(19) United States
(12) Patent Application Publication
(10) Pub. No.: US 2008/0231500 A1
(43) Pub. Date: Sep. 25, 2008

(54) Receiving method and receiver

(75) Inventors: Markku J. Heikkila, Oulu (FI); Tuomas Saukkonen, Kempele (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/790,911

(22) Filed: Apr. 27, 2007

(30) Foreign Application Priority Data
Feb. 23, 2007 (FI) 20070156

(51) Int. Cl. H04B 15/00

(52) U.S. Cl. 342/159

(57) ABSTRACT

There is provided a receiver comprising: an estimator configured to estimate an initial noise-plus-interference covariance matrix on the basis of a received signal; a calculator configured to calculate a parameter using the received signal; and a calculator configured to decrease magnitude of off-diagonal values of the estimated initial covariance matrix relative to diagonal values of the same matrix based on the calculated parameter in order to estimate a final noise-plus-interference covariance matrix.

### FIELD

The invention relates to a receiving method, to a receiver, to a radio system, and to a computer-readable program distribution medium.

### BACKGROUND

Considerable performance gains have been achieved lately in radio systems, such as the EUTRAN (enhanced UMTS terrestrial radio access network) LTE (long term evolution), by using Interference Rejection Combining (IRC) receivers. The desired signal is impaired by interference from neighboring cells due to frequency reuse 1, i.e. neighboring cells using the same frequency band. Interference rejecting receivers apply baseband signal processing in order to linearly suppress the intercell interference either in SIMO (single-input multiple-output) or MIMO (multiple-input multiple-output) detection.

Current receivers are based on statistical signal models, the accuracy of which cannot be relied on in all situations. A known combining method that can reduce the impact of noise and interference is Interference Rejection Combining (IRC). IRC receivers can be used for signal detection in SIMO channels, for example. IRC is based on an estimated spatial noise covariance matrix, which is used for solving optimal antenna combining weights. A detector can be a simple antenna combiner that weights signal samples corresponding to a certain subcarrier from two antenna branches by complex weighting factors. In addition, QRD-M (QR decomposition, M algorithm), SIC (successive interference cancellation) or PIC (parallel interference cancellation) detectors can be used for MIMO detection. These receivers are beneficial if good quality noise covariance estimates are utilized in the detectors used. The use of noise covariance also reduces effects of transmitter imperfections (EVM).

IRC provides gain compared e.g. to a maximal ratio combiner (MRC) if interference-plus-noise is spatially colored. In the same way, use of noise covariance matrix in QRD-M or PIC detectors improves MIMO performance. A problem, however, is that the quality of the noise covariance matrix estimate may be poor, especially in frequency selective channels. If the noise is only slightly colored or even spatially uncorrelated, then IRC causes performance loss compared to MRC. This is because a loss due to an estimation error exceeds the possible gain achieved from interference suppression. The loss can be substantial, which reduces the average system level gain due to IRC detection significantly. This problem may prevent the use of IRC detection or the use of noise covariance estimation in general in receivers, despite its potential performance gain.

### BRIEF DESCRIPTION OF THE INVENTION

An object of the invention is to provide an improved receiving method, a receiver, a radio system, and a computer-readable program distribution medium.

According to an aspect of the invention, there is provided a receiving method, comprising: estimating an initial noise-plus-interference covariance matrix on the basis of a received signal; calculating a parameter using the received signal; and decreasing magnitude of off-diagonal values of the estimated initial covariance matrix relative to diagonal values of the same matrix based on the calculated parameter in order to estimate a final noise-plus-interference covariance matrix.

According to another aspect of the invention, there is provided a receiver comprising: an estimator configured to estimate an initial noise-plus-interference covariance matrix on the basis of a received signal; a calculator configured to calculate a parameter using the received signal; and a calculator configured to decrease magnitude of off-diagonal values of the estimated initial covariance matrix relative to diagonal values of the same matrix based on the calculated parameter in order to estimate a final noise-plus-interference covariance matrix.

According to another aspect of the invention, there is provided a radio system including at least one receiver comprising: an estimator configured to estimate an initial noise-plus-interference covariance matrix on the basis of a received signal; a calculator configured to calculate a parameter using the received signal; and a calculator configured to decrease magnitude of off-diagonal values of the estimated initial covariance matrix relative to diagonal values of the same matrix based on the calculated parameter in order to estimate a final noise-plus-interference covariance matrix.

According to another aspect of the invention, there is provided a computer-readable program distribution medium encoding a computer program of instructions for executing a computer process comprising: estimating an initial noise-plus-interference covariance matrix on the basis of a received signal; calculating a parameter using the received signal; and decreasing magnitude of off-diagonal values of the estimated initial covariance matrix relative to diagonal values of the same matrix based on the calculated parameter in order to estimate a final noise-plus-interference covariance matrix.

According to another aspect of the invention, there is provided a receiver comprising: estimating means for estimating an initial noise-plus-interference covariance matrix on the basis of a received signal; calculating means for calculating a parameter using the received signal; and calculating means for decreasing magnitude of off-diagonal values of the estimated initial covariance matrix relative to diagonal values of the same matrix based on the calculated parameter in order to estimate a final noise-plus-interference covariance matrix.

According to another aspect of the invention, there is provided a radio system including at least one receiver comprising: estimating means for estimating an initial noise-plus-interference covariance matrix on the basis of a received signal; calculating means for calculating a parameter using the received signal; and calculating means for decreasing magnitude of off-diagonal values of the estimated initial covariance matrix relative to diagonal values of the same matrix based on the calculated parameter in order to estimate a final noise-plus-interference covariance matrix.

The invention provides several advantages. Performance loss is eliminated in situations where interference is at least nearly spatially uncorrelated. A robust method for detecting low spatial noise correlation is enabled.

### LIST OF DRAWINGS

In the following, the invention will be described in greater detail with reference to embodiments and the accompanying drawings, in which

FIG. 1 shows an example of a radio system;

FIG. 2 illustrates another example of a radio system;

FIG. 3 illustrates an example of a receiver according to an embodiment of the invention; and

FIG. 4 illustrates an example of a receiving method according to an embodiment of the invention.

### DESCRIPTION OF EMBODIMENTS

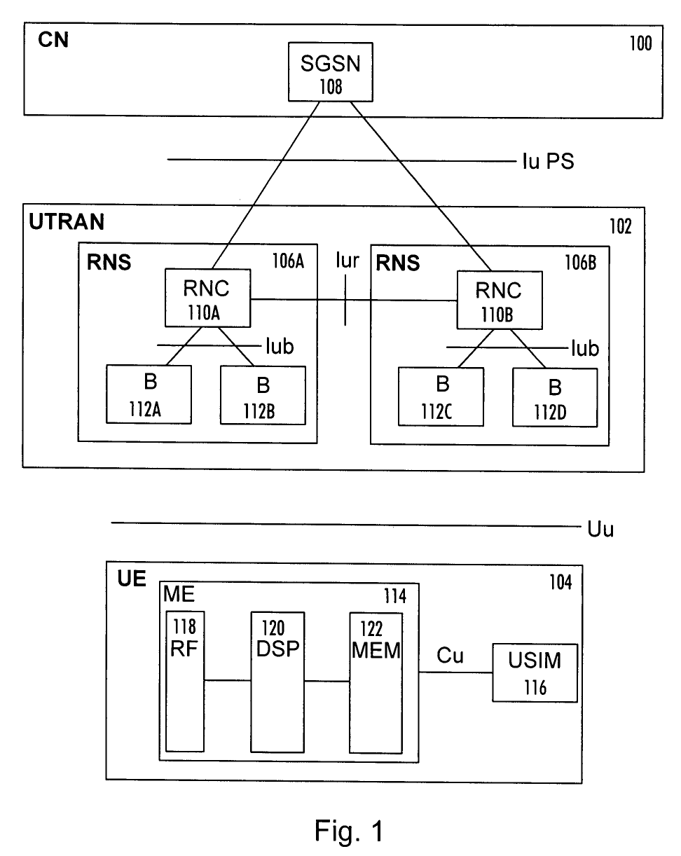

FIG. 1 illustrates an example of a radio system to which the present solution may be applied. Below, embodiments of the invention will be described using the UMTS (Universal Mobile Telecommunications System) as an example of the radio system. The invention may, however, be applied to any wireless telecommunications system that supports FDMA (frequency division multiple access) system elements. The structure and functions of such a wireless telecommunications system and those of the associated network elements are only described when relevant to the invention.

The wireless telecommunications system may be divided into a core network (CN) 100, a UMTS terrestrial radio access network (UTRAN) 102, and a user terminal (UE) 104. The core network 100 and the UTRAN 102 compose a network infrastructure of the wireless telecommunications system.

The UTRAN 102 is typically implemented with wideband code division multiple access (WCDMA) radio access technology.

The core network 100 includes a serving GPRS support node (SGSN) 108 connected to the UTRAN 102 over an lu PS interface. The SGSN 108 represents the center point of the packet-switched domain of the core network 100. The main task of the SGSN 108 is to transmit packets to the user terminal 104 and to receive packets from the user terminal 104 by using the UTRAN 102. The SGSN 108 may contain subscriber and location information related to the user terminal 104.

The UTRAN 102 includes radio network sub-systems (RNS) 106A, 106B, each of which includes at least one radio network controller (RNC) 110A, 110B and nodes B 112A, 112B, 112C, 112D.

Some functions of the radio network controller 110A, 110B may be implemented with a digital signal processor, memory, and computer programs for executing computer processes. The basic structure and operation of the radio network controller 110A, 110B are known to one skilled in the art and only details relevant to the present solution are discussed in detail.

Node B 112A, 112B, 112C, 112D implements the Uu interface, through which the user terminal 104 may access the network infrastructure. Some functions of the base station 112A, 112B, 112C, 112D may be implemented with a digital signal processor, memory, and computer programs for executing computer processes. The basic structure and operation of the base station 112A, 112B, 112C, 112D are known to one skilled in the art and only details relevant to the present solution are discussed in detail.

The user terminal 104 may include two parts: mobile equipment (ME) 114 and a UMTS subscriber identity module (USIM) 116. The mobile equipment 114 typically includes radio frequency parts (RF) 118 for providing the Uu interface. The user terminal 104 further includes a digital signal processor 120, memory 122, and computer programs for executing computer processes. The user terminal 104 may further comprise an antenna, a user inter-face, and a battery not shown in FIG. 1. The USIM 116 comprises user-related information and information related to information security in particular, for instance, an encryption algorithm.

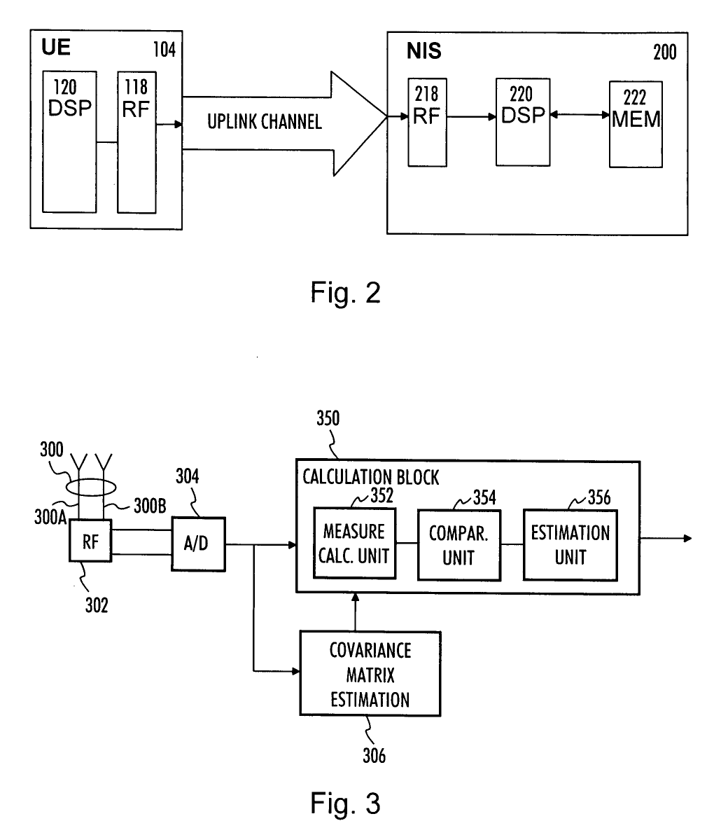

FIG. 2 illustrates another example of a radio system. The radio system comprises a network infrastructure (NIS) 200 and a user terminal (UE) 104. The user terminal 104 may be connected to the network infrastructure 200 over an uplink physical data channel, such as a DPDCH (Dedicated Physical Data channel) defined in the 3GPP specification.

In FIG. 2, only one user terminal 104 is shown. However, it is assumed that there can be several user terminals 104 that share a common frequency band for communicating with the network infrastructure 200. The user terminals 104 may be scattered throughout the coverage area of the network infrastructure 200, which may be divided into cells, each cell being associated with Node B. The user terminals within a cell may be served by the Node B associated with the cell. If a user terminal resides at the edge of a cell, the user terminal may be served by one or more nodes B associated with adjacent cells.

The radio system may employ several data modulation schemes in order to transfer data between the user terminals 104 and the network infrastructure 200 with variable data rates. The radio system may employ, for example, quadrature phase shift keying (QPSK) and quadrature amplitude modulation (QAM) modulation schemes. Several coding schemes may also be implemented with different effective code rates (ECR).

The user terminal 104 comprises a signal-processing unit 120 for controlling the functions of the user terminal, and a transmitting/receiving unit 118 for communicating with the network infrastructure 200. The network infrastructure 200 comprises a transmitting/receiving unit 218, which carries out channel encoding of transmission signals, converts them from the baseband to the transmission frequency band and modulates and amplifies the transmission signals. A signal-processing unit DSP 220 controls the operation of the network element and evaluates signals received via the transmitting/receiving unit 218. The network infrastructure 200 may also include a memory 222.

FIG. 3 illustrates an example of a receiver according to an embodiment of the invention. The receiver may reside in any part of the radio system, such as the network infrastructure 200 and the user equipment 104.

The receiver comprises signal receiving means, such as one or more array antennas 300 with two antenna elements 300A, 300B. However, it is also possible to use antennas with only one antenna element. The received signal is processed in the radio frequency (RF) parts 302 of the receiver. In the RF parts, the radio frequency signal is transferred either to intermediate frequency or to a base band frequency. The down-converted signal is taken to an A/D-converter 304, where the signal is oversampled. The samples are further processed in one or more calculation means 306, 350, 352, 354, and 356. The different calculation means 306, 350, 352, 354, and 356 of FIG. 3 can be implemented by means of one or more processors programmed by appropriate software, or in the form of hardware components, such as integrated circuits, discrete components, or a combination of any of these, which are evident to one skilled in the art.

In an embodiment, a covariance estimation block 306 receives signals from the A/D-converter 304 and estimates an initial noise and interference covariance matrix on the basis of the received signal. The noise and interference covariance matrix provides a representation of the correlation of noise and interference between the received signals. In an embodiment, a calculation unit 352 in a calculation block 350 calculates a parameter using the received signal, and an estimation unit 356 decreases the magnitude of off-diagonal values of the estimated initial covariance matrix relative to diagonal values of the same matrix based on the calculated parameter in order to estimate a final noise-plus-interference covariance matrix. Finally, the received signal is detected on the basis of the final noise-plus-interference covariance matrix.

In an embodiment, the calculation block 350 receives the initial noise and interference covariance matrix from the covariance estimation block 306, and calculates the parameter by calculating a ratio between at least some of the off-diagonal values and diagonal values of the estimated initial covariance matrix. In an embodiment, a comparison unit 354 compares the ratio between at least some of the off-diagonal values and diagonal values to a threshold value, and the estimation unit 356 decreases the magnitude of off-diagonal values of the estimated initial covariance matrix when the ratio is below the threshold value.

In another embodiment, the calculation unit 352 calculates the parameter by estimating a channel coherence bandwidth in order to determine the quality of the initial noise-plus-interference covariance matrix, and the estimation unit 356 decreases the magnitude of off-diagonal values relative to diagonal values of the same matrix on the basis of the determined quality of the initial noise-plus-interference covariance matrix.

In an embodiment, the calculation unit 352 calculates the parameter by estimating a dominant interference ratio in order to determine the quality of the initial noise-plus-interference covariance matrix, and the estimation unit 356 decreases the magnitude of off-diagonal values on the basis of the determined quality of the initial noise-plus-interference covariance matrix.

Let us examine the theoretical background of the disclosed solution. In an OFDM (orthogonal frequency division multiplexing) or OFDMA (orthogonal frequency division multiple access) receiver, a Fast Fourier Transform (FFT) is taken from a vector of time-domain signal samples received through a receive antenna. After N-point FFT, the resulting frequency-domain signal consists of N signal samples, one for each subcarrier. In the case of M receive antennas, M samples are available for each of the N subcarriers. The received signal corresponding to subcarrier k can be presented as:

$$r ( k ) = ( \begin{matrix}{r}_{1} ( k ) \\ {r}_{2} ( k ) \\ ⋮ \\ {r}_{M} ( k )\end{matrix} ) = h ( k ) s ( k ) + n ( k ) \qquad ( 1 )$$

where r(k) is the received signal, r_{M}(k) is a received signal element of Mth receive antenna, vector h(k) has M elements and represents the channel response from the transmitter of the desired signal to the receive antennas. Further, s(k) represents a data symbol, vector n(k) represents noise-plus-interference including thermal noise but also any interfering signals coming e.g. from neighboring cells or sectors in a cellular network.

A detector estimates (detects) a data symbol s(k) using r(k). Linear Minimum Mean-Square Error (LMMSE) estimation filter can be presented as:

w(k)=(h(k)h^{H}(k)+C(k))⁻¹h(k) (2)

where C(k) is the M×M covariance matrix of the noise-plus-interference in subcarrier k. In the case of two receive antennas, it can be written as:

$$C ( k ) = ( \begin{matrix}{P}_{1} ( k ) & {α}_{12} ( k ) \\ {α}_{21} ( k ) & {P}_{2} ( k )\end{matrix} ) = E ( n ( k ) {n}^{H} ( k ) ) \qquad ( 3 )$$

where α₁₂(k) is an estimate of correlation of interference between receiving antennas, α₁₂*(k) is a complex conjugate of α₁₂(k), P₁(k) and P₂(k) are estimates of interference power in the receiving antennas in a subcarrier k, E denotes expectation.

The LMMSE symbol estimate can be obtained as:

\hat{s}(k)=w^{H}(k)r(k) (4).

Instead of using equation (2), it is also possible to apply:

w(k)=C⁻¹(k)h(k) (5)

where the effect of the desired signal is excluded from the matrix. This, however, affects only the scaling of the resulting symbol estimate.

Both (2) and (5) utilize matrix C(k) to suppress possible spatially colored noise-plus-interference. In many practical applications the matrix has to be estimated. The inevitable estimation errors will degrade the quality of (2) and/or (5).

An estimate C(k) matrix can also be used in other detector algorithms to detect the unknown symbol s(k). An example is a Maximum Likelihood (ML) estimator of s(k). ML estimate given r(k) is:

$$\hat{s} ( k ) = arg {min}_{s ( k )} {( r ( k ) - h ( k ) s ( k ) )}^{H} {C}^{- 1} ( k ) ( r ( k ) - h ( k ) s ( k ) ) . \qquad ( 6 )$$

If C(k) is reliably estimated, also the ML detector becomes more robust against noise-plus-interference. However, as in the case of LMMSE estimator (2), the performance loss due to estimation errors in C(k) may be larger than the gain due to (suboptimal) interference suppression. An embodiment of the invention thus aims at pre-modifying the estimated noise covariance to reduce the possible performance loss compared to a receiver that does not try to estimate a full noise-covariance matrix or does not user it at all.

The pre-modification of the estimate of C(k) is particularly useful if the channel conditions are such that either:
reliable estimation of C(k) is not possible (e.g. due to very narrow channel coherence bandwidth), or
the noise-plus-interference, n(k), is spatially uncorrelated or nearly uncorrelated (i.e. noise samples in each receiving antenna do not correlate significantly, which implies that the ideal noise covariance matrix is a diagonal or near-diagonal matrix).

The situation of the first bullet point may be identified e.g. by calculating a parameter, such as a channel coherence bandwidth, and comparing the value to a critical threshold value. The situation of the second bullet point may be identified by estimating a dominant-to-interference ratio (DIR). Alternatively, it is possible to calculate a parameter using elements of the estimated channel covariance matrices. In the case of two receiving antennas, a suitable parameter is a ratio:

$$c = \frac{{\sum }_{k} {α}_{12} ( k ) {α}_{12}^{*} ( k )}{{\sum }_{k} {P}_{1} ( k ) {P}_{2} ( k )} \qquad ( 7 )$$

where the sum (average) is taken over a sufficient number of subcarriers, and where parameter c is a measure of spatial color of interference, α₁₂(k) is an estimate of correlation of interference between receiving antennas, α₁₂*(k) is a complex conjugate of α₁₂(k), P₁(k) and P₂(k) are estimates of interference power in the receiving antennas in a subcarrier k. If the parameter c is below a predetermined threshold value (e.g. c<0.1), it indicates that the noise-plus-interference is nearly spatially uncorrelated.

The above parameters can be used for indicating whether the conditions are such that reliable estimation of the noise-plus-interference matrix is (or is not) possible. An estimate can be considered reliable if using the estimated matrix provides performance gain compared with some other method of signal detection. It is possible to compare the parameter with a threshold value for identifying a situation where a reliable estimation is not possible and then pre-modify the estimated matrix for avoiding or reducing performance loss. Alternatively, the parameter can be used for gradually pre-modifying the estimated matrix such that no definite threshold value is used.

It is also possible that the received signal samples of signal vector (1) are not obtained by sampling the signal of M receive antennas (spatial sampling), but by sampling the signal of a single receive antenna at M different time instants (time domain sampling). A combination of these two sampling methods is also possible, that is, for obtaining the signal samples from several receive antennas sampled at several time instants. While spatial sampling of the frequency domain signal assumed in (1) is especially useful for OFDM or OFDMA detection, the other methods are useful for signal detection e.g. in CDMA, WCDMA and GSM systems, which suffer from time dispersion of the signal.

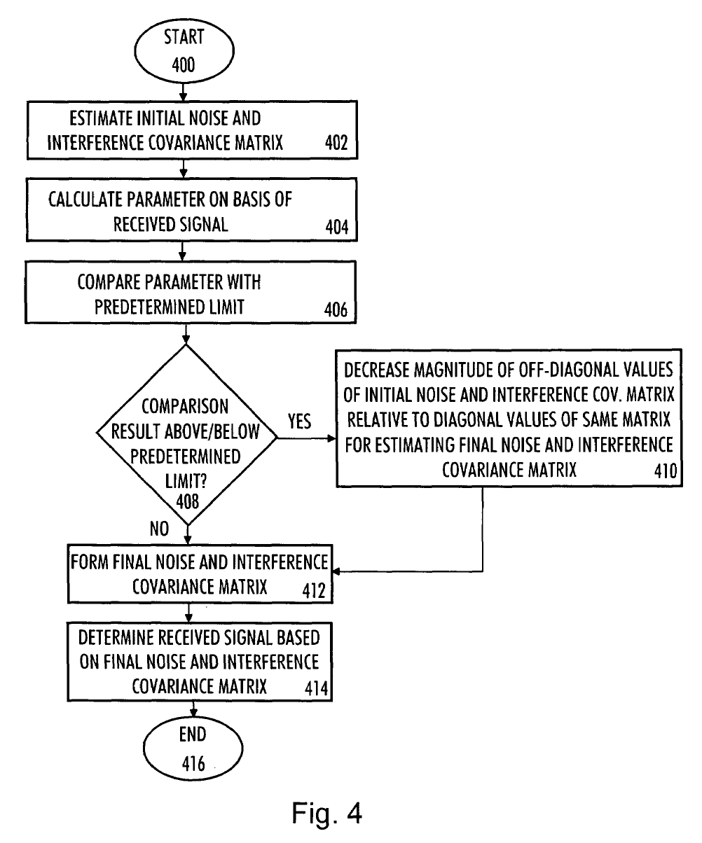

FIG. 4 illustrates an example of a receiving method according to an embodiment of the invention. The method starts in 400. In 402, an initial noise-plus-interference covariance matrix is estimated on the basis of received signal samples. In 404, a parameter is calculated using the received signal. In 406, the calculated parameter is compared with a predetermined limit/threshold value. If it is determined, in 408, that the parameter exceeds or is below the predetermined limit, then 410 can be entered, otherwise 412 is entered.

In 410, the magnitude of off-diagonal values of the estimated initial covariance matrix is decreased relative to diagonal values of the same matrix based on the calculated parameter in order to estimate a final noise-plus-interference covariance matrix. In 412, the final noise-plus-interference covariance matrix is formed. Finally, in 414, the received signal samples are combined on the basis of the final noise-plus-interference covariance matrix. The method ends in 416.

The embodiments of the invention provide a simple method of preventing almost any performance loss in unfavourable situations due to use of estimated noise covariance matrix in IRC, QRD-M or SIC detectors, for example. It can also be used with ML (maximum likelihood) or MAP (maximum aposteriori probability) detectors when an estimated noise covariance matrix is used.

In an embodiment, a target is to monitor the average structure of the estimated noise-plus-interference covariance matrix that is used for computing IRC antenna combining weights or in some other way for interference rejection in an LTE detector, for example. Assuming that there are two receiving antennas, the noise-plus-interference covariance matrix can have the form described in the above equation (3) for an OFDM subcarrier k. The matrix is a symmetric 2×2 matrix, the diagonal values of which are estimates of interference power in the receiving antennas in subcarrier k. The complex off-diagonal values constitute a measure of the correlation of interference between antennas.

In an embodiment, when the absolute off-diagonal values of the covariance matrix relative to its diagonal values are below a threshold, the off-diagonal values are set to zero. Thus, interference rejection is not used when the expected gain is zero or negative. In another embodiment, it is possible to decrease the magnitude of the off-diagonal values by a certain amount.

An example of a reliable measure of spatial color of interference was described in the above equation (7) for two receiving antennas. The same principle can also be applied to receivers having more than two antennas. The averaging can be carried out at a slow rate over several subcarriers and/or OFDM symbols. The value of (7) is almost independent of average SNR (signal-to-noise ratio) (e.g. G factor), input signal level or channel profile and, thus, a fixed threshold (e.g. 0.2) to which (1) can be compared may be used. A suitable threshold value can be determined by running simulations and studying which threshold gives the best performance on the average. It is also possible to use a variable threshold, e.g. one for channels with large coherence bandwidth, and another for channels with low coherence bandwidth. In an embodiment, instead of using a hard limited threshold, the off-diagonal values are continuously adjusted in a soft manner.

In an embodiment, a channel coherence bandwidth is estimated for determining situations where the estimation accuracy of the noise covariance matrix is not acceptable. This is because a narrow coherence bandwidth allows less averaging for obtaining the estimate. In another embodiment, also DIR (dominant interference ratio, power ratio of dominant interferer and all other interference) can be estimated and compared with a threshold. If DIR is small, indicating low spatial noise correlation, off-diagonal elements of the noise covariance matrix can be set to zero.

The implementation of the proposed system is simple. Forcing the off-diagonal elements to zero can be carried out in a covariance matrix estimation block or in an IRC tap solver, for example. If equation (7) is used, a sufficient number of samples should be used for averaging. Possible threshold comparisons can be carried out in practice at a very low rate such that no large computational overhead is caused.

In an embodiment, the modification is based on a parameter that is obtained by using the received signal, and the off-diagonal values of the matrix are then decreased while the diagonal values are not increased. This is because increasing the diagonal values would provide a receiver (detector) wrong information about the noise level of the received signal as is the case when using a known method called “diagonal loading” of a matrix where diagonal values of the matrix are increased by adding a constant (a diagonal matrix) to them for stabilizing the matrix (thus, providing a less ill-conditioned and more reliably inverted matrix).

The embodiments of the invention may be realized in an electronic device, comprising a controller configured to perform at least some of the steps described in connection with the flowchart of FIG. 4 and in connection with FIGS. 2 and 3. The embodiments may be implemented as a computer program comprising instructions for executing a computer process for receiving signals.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

The techniques described herein may be implemented by various means. For example, these techniques may be implemented in hardware (one or more devices), firmware (one or more devices), software (one or more modules), or combinations thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For a firmware or software, implementation can be through modules (e.g., procedures, functions, and so on) that perform the functions described herein. The software codes may be stored in a memory unit and executed by the processors. The memory unit may be implemented within the processor or external to the processor, in which case it can be communicatively coupled to the processor via various means as is known in the art. Additionally, components of systems described herein may be rearranged and/or complimented by additional components in order to facilitate achieving the various aspects, goals, advantages, etc., described with regard thereto, and are not limited to the precise configurations set forth in the given figures, as will be appreciated by one skilled in the art.

Even though the invention has been described above with reference to an example according to the accompanying drawings, it is clear that the invention is not restricted thereto but it can be modified in several ways within the scope of the appended claims.

1. A receiving method, comprising:
estimating an initial noise-plus-interference covariance matrix based on a received signal;
calculating a parameter using the received signal; and
decreasing magnitude of off-diagonal values of the estimated initial covariance matrix relative to diagonal values of the estimated initial covariance matrix based on the calculated parameter to estimate a final noise-plus-interference covariance matrix.

2. The method of claim 1, the method further comprising:
detecting the received signal based on the final noise-plus-interference covariance matrix.

3. The method of claim 1, wherein the calculating the parameter comprises calculating a ratio between at least some of the off-diagonal values and diagonal values of the estimated initial covariance matrix.

4. The method of claim 3, further comprising:
comparing the ratio between the at least some of the off-diagonal values and diagonal values to a threshold value; and
decreasing the magnitude of off-diagonal values of the estimated initial covariance matrix when the ratio is below the threshold value.

5. The method of claim 3, calculating the ratio based on the following equation:
$$c = \frac{{\sum }_{k} {α}_{12} ( k ) {α}_{12}^{*} ( k )}{{\sum }_{k} {P}_{1} ( k ) {P}_{2} ( k )} ,$$
wherein parameter c is a measure of spatial color of interference, wherein α₁₂(k) is an estimate of correlation of interference between receiving antennas, wherein α₁₂*(k) is a complex conjugate of α₁₂(k), and wherein P₁(k) and P₂(k) are estimates of interference power in the receiving antennas in a subcarrier k.

6. The method of claim 1, wherein the calculating the parameter comprises estimating a channel coherence bandwidth to determine the quality of the initial noise-plus-interference covariance matrix and decreasing the magnitude of off-diagonal values relative to diagonal values of the initial noise-plus-interference covariance matrix based on the determined quality of the initial noise-plus-interference covariance matrix.

7. The method of claim 1, wherein the calculating the parameter comprises estimating a dominant interference ratio to determine quality of the initial noise-plus-interference covariance matrix and decreasing the magnitude of off-diagonal values based on the determined quality of the initial noise-plus-interference covariance matrix.

8. The method of claim 1, further comprising:
decreasing the magnitude of off-diagonal values of the estimated initial covariance matrix to zero.

9. A receiver comprising:
an estimator configured to estimate an initial noise-plus-interference covariance matrix based on a received signal;
a calculator configured to calculate a parameter using the received signal; and
a calculator configured to decrease magnitude of off-diagonal values of the estimated initial covariance matrix relative to diagonal values of the estimated initial covariance matrix based on the calculated parameter to estimate a final noise-plus-interference covariance matrix.

10. The receiver of claim 9, further comprising:
a detector configured to detect the received signal based on the final noise-plus-interference covariance matrix.

11. The receiver of claim 9, wherein the calculator configured to calculate the parameter is configured to calculate a ratio between at least some of the off-diagonal values and diagonal values of the estimated initial covariance matrix.

12. The receiver of claim 11, wherein the calculator configured to calculate the parameter is further configured to compare the ratio between the at least some of the off-diagonal values and diagonal values to a threshold value and wherein the calculator configured to calculate the parameter is further configured to decrease the magnitude of off-diagonal values of the estimated initial covariance matrix when the ratio is below the threshold value.

13. The receiver of claim 11, wherein the calculator configured to calculate the parameter is configured to calculate the ratio based on the following equation:
$$c = \frac{{\sum }_{k} {α}_{12} ( k ) {α}_{12}^{*} ( k )}{{\sum }_{k} {P}_{1} ( k ) {P}_{2} ( k )} ,$$
wherein parameter c is a measure of spatial color of interference, wherein α₁₂(k) is an estimate of correlation of interference between receiving antennas, wherein α₁₂*(k) is a complex conjugate of α₁₂(k), and wherein P₁(k) and P₂(k) are estimates of interference power in the receiving antennas in a subcarrier k.

14. The receiver of claim 9, wherein the calculator configured to calculate the parameter is configured to estimate a channel coherence bandwidth to determine quality of the initial noise-plus-interference covariance matrix and wherein the calculator configured to calculate the parameter is configured to decrease the magnitude of off-diagonal values relative to diagonal values of the initial noise-plus-interference covariance matrix based on the determined quality of the initial noise-plus-interference covariance matrix.

15. The receiver of claim 9, wherein the calculator configured to calculate the parameter is configured to estimate a dominant interference ratio to determine the quality of the initial noise-plus-interference covariance matrix and wherein the calculator configured to calculate the parameter is configured to decrease the magnitude of off-diagonal values based on the determined quality of the initial noise-plus-interference covariance matrix.

16. The receiver of claim 9, wherein the calculator configured to decrease the magnitude of off-diagonal values is configured to decrease the magnitude of the off-diagonal values of the estimated initial covariance matrix to zero.

17. A radio system including at least one receiver, the receiver comprising:
an estimator configured to estimate an initial noise-plus-interference covariance matrix based on a received signal;
a calculator configured to calculate a parameter using the received signal; and
a calculator configured to decrease magnitude of off-diagonal values of the estimated initial covariance matrix relative to diagonal values of the estimated initial covariance matrix based on the calculated parameter to estimate a final noise-plus-interference covariance matrix.

18. The radio system of claim 17, wherein the calculator configured to calculate the parameter is configured to calculate a ratio between at least some of the off-diagonal values and diagonal values of the estimated initial covariance matrix.

19. The radio system of claim 18, wherein the calculator configured to calculate the parameter is further configured to compare the ratio between the at least some of the off-diagonal values and diagonal values to a threshold value and wherein the calculator configured to calculate the parameter is configured to decrease the magnitude of off-diagonal values of the estimated initial covariance matrix when the ratio is below the threshold value.

20. The radio system of claim 18, wherein the calculator configured to calculate the parameter is configured to calculate the ratio based on the following equation:
$$c = \frac{{\sum }_{k} {α}_{12} ( k ) {α}_{12}^{*} ( k )}{{\sum }_{k} {P}_{1} ( k ) {P}_{2} ( k )} ,$$
wherein parameter c is a measure of spatial color of interference, wherein α₁₂(k) is an estimate of correlation of interference between receiving antennas, wherein α₁₂*(k) is a complex conjugate of α₁₂(k), and wherein P₁(k) and P₂(k) are estimates of interference power in the receiving antennas in a subcarrier k.

21. The radio system of claim 17, wherein the calculator configured to calculate the parameter is configured to estimate a channel coherence bandwidth to determine quality of the initial noise-plus-interference covariance matrix and wherein the calculator configured to calculate the parameter is configured to decrease the magnitude of off-diagonal values relative to diagonal values of the initial noise-plus-interference covariance matrix based on the determined quality of the initial noise-plus-interference covariance matrix.

22. The radio system of claim 17, wherein the calculator configured to calculate the parameter is configured to estimate a dominant interference ratio to determine the quality of the initial noise-plus-interference covariance matrix and wherein the calculator configured to calculate the parameter is configured to decrease the magnitude of off-diagonal values based on the determined quality of the initial noise-plus-interference covariance matrix.

23. A computer-readable program distribution medium encoding a computer program of instructions for executing a computer process comprising:
estimating an initial noise-plus-interference covariance matrix based on a received signal;
calculating a parameter using the received signal; and
decreasing magnitude of off-diagonal values of the estimated initial covariance matrix relative to diagonal values of the estimated initial covariance matrix based on the calculated parameter to estimate a final noise-plus-interference covariance matrix.

24. The computer program distribution medium of claim 23, the computer process further comprising:
detecting the received signal based on the final noise-plus-interference covariance matrix.

25. The computer program distribution medium of claim 23, the distribution medium comprising at least one of the following media: a computer readable medium, a program storage medium, a record medium, a computer readable memory, a computer readable software distribution package, a computer readable signal, a computer readable telecommunications signal, or a computer readable compressed software package.

26. A receiver comprising:
estimating means for estimating an initial noise-plus-interference covariance matrix based on a received signal;
calculating means for calculating a parameter using the received signal; and
calculating means for decreasing magnitude of off-diagonal values of the estimated initial covariance matrix relative to diagonal values of the estimated initial covariance matrix based on the calculated parameter to estimate a final noise-plus-interference covariance matrix.

27. The receiver of claim 26, further comprising:
calculating means for calculating a ratio between at least some of the off-diagonal values and diagonal values of the estimated initial covariance matrix; comparing means for comparing the ratio between at least some of the off-diagonal values and diagonal values to a threshold value; and
calculating means for decreasing the magnitude of off-diagonal values of the estimated initial covariance matrix when the ratio is below the threshold value.

28. The receiver of claim 26, further comprising:
estimating means for estimating a channel coherence bandwidth to determine quality of the initial noise-plus-interference covariance matrix; and
calculation means for decreasing the magnitude of off-diagonal values relative to diagonal values of the initial noise-plus-interference covariance matrix based on the determined quality of the initial noise-plus-interference covariance matrix.

29. The receiver of claim 26, further comprising:
estimating means for estimating a dominant interference ratio to determine the quality of the initial noise-plus-interference covariance matrix; and
calculation means for decreasing the magnitude of off-diagonal values based on the determined quality of the initial noise-plus-interference covariance matrix.

30. A radio system including at least one receiver, the receiver comprising:
estimating means for estimating an initial noise-plus-interference covariance matrix based on a received signal;
calculating means for calculating a parameter using the received signal; and
calculating means for decreasing magnitude of off-diagonal values of the estimated initial covariance matrix relative to diagonal values of the estimated initial covariance matrix based on the calculated parameter to estimate a final noise-plus-interference covariance matrix.

31. The radio system of claim 30, further comprising:
calculating means for calculating a ratio between at least some of the off-diagonal values and diagonal values of the estimated initial covariance matrix; comparing means for comparing the ratio between at least some of the off-diagonal values and diagonal values to a threshold value; and
calculating means for decreasing the magnitude of off-diagonal values of the estimated initial covariance matrix when the ratio is below the threshold value.

32. The radio system of claim 30, further comprising:
estimating means for estimating a channel coherence bandwidth to determine quality of the initial noise-plus-interference covariance matrix; and
calculation means for decreasing the magnitude of off-diagonal values relative to diagonal values of the initial noise-plus-interference covariance matrix based on the determined quality of the initial noise-plus-interference covariance matrix.

33. The radio system of claim 30, further comprising:
estimating means for estimating a dominant interference ratio to determine the quality of the initial noise-plus-interference covariance matrix; and
calculation means for decreasing the magnitude of off-diagonal values based on the determined quality of the initial noise-plus-interference covariance matrix.
